(19) United States
(12) Patent Application Publication
(10) Pub. No.: US 2019/0209980 A1
(43) Pub. Date: Jul. 11, 2019

(54) GAS TO GAS ASPIRATOR WITH IMPROVED ENTRAINMENT EFFICIENCY

(71) Applicant: DLHBOWLES, INC., Canton, OH (US)

(72) Inventors: Corey ZAMENSKI, Essex, MD (US); Shridhar GOPALAN, Westminster, MD (US)

(21) Appl. No.: 16/324,154

(22) PCT Filed: Oct. 2, 2017
(86) PCT No.: PCT/US2017/054736

§ 371 Date: Feb. 8, 2019

Related U.S. Application Data
(60) Provisional application No. 62/403,511, filed on Oct. 3, 2016.

(51) Int. Cl. B01F 5/04; B01F 3/02

(52) U.S. Cl. CPC B01F 5/043; B01F 3/02; B01F 2215/0431; B01F 2005/0433; B01F 2215/0422; B01F 2005/0441

(57) ABSTRACT

An eductor type gas to gas aspirator having improved entrainment efficiency includes a motive gas nozzle configured with a distal tip having an arcuate internal profile that converges in a downstream direction. The arcuate internal profile preferably has sinusoidal convergence curvature. In a preferred embodiment, the length Lₛ of the nozzle tip is between 2D and 4D where D is the diameter of said outlet orifice, and the distance L_{d} between nozzle outlet orifice and the upstream end of and out let barrel passage is between 0 and D.

### CROSS REFERENCE TO RELATED APPLICATIONS

The present application is a non-provisional application claiming the benefit of U.S. Provisional Application No. 62/403,511, entitled “High Entrainment Gas to Gas Venturi Aspirator Apparatus and Method”, filed Oct. 3, 2016, the disclosure of which is hereby incorporated by reference in its entirety.

### BACKGROUND

### Technical Field

The present invention pertains to aspiration devices and methods for gas to gas entrainment/mixing and, more particularly to improved eductor-type nozzles configured to optimize entrainment efficiency.

### Discussion of the Prior Art

There is currently a need in many gas to gas aspirator applications for increasing the gas entrainment efficiency, ν, defined as the ratio of the entrained gas flow rate to the motive gas flow rate. Included in such applications are the purging fuel vapors in an evaporative emissions system, spa applications, vacuum pump applications, gas to gas mixing applications, etc. In vehicle emission control systems, for example, in order to meet automotive emissions standards, some vehicles with turbocharged engines utilize a dual path evaporative emissions system in which a boost leak or other means is used as the inlet air for an aspirator device to provide a pressure differential with respect to atmosphere to entrain the required amount of air to purge the fuel tank of fuel vapors. In any of these applications it would be advantageous to have an aspirator device that could entrain the required amount of aspirated gas with a decrease in the flow of the motive gas to provide improved entrainment efficiency. There are also applications in which it is desirable for the entrainment efficiency to be improved by having the entrained air flow be increased and the inlet flow rate remain the same.

A cost-effective type of aspirator requiring minimal maintenance is the eductor type which has no moving parts and wherein motive fluid is issued from an interior nozzle terminating in a nozzle tip located at or near the entrance to a Venturi restriction. Entrained gaseous fluid is drawn into the unit, from the surrounding environment or from a system component via a hose or other fluid passage, at a location upstream of the nozzle tip. The internal profile of the motive fluid nozzle, along which the motive gas flows, is typically linearly convergent to the nozzle tip, a configuration which we have found to not be optimally efficient for the entrainment. See, as an example of such a nozzle, the eductor aspirator disclosed in U.S. Pat. No. 8,448,629 (Makino et al) the entire disclosure of which is incorporated herein by reference. Thus, cost-effective as they may be, the entrainment efficiency for conventional gas to gas eductor aspirators is typically less than two. It would be desirable to increase the entrainment efficiency for such aspirators to a value of three or greater (i.e., ν>3).

### OBJECTS AND SUMMARY OF THE INVENTION

Therefore, in light of the above, and for other reasons that become apparent when the invention is fully described, it is an object of the present invention to provide a method and apparatus that substantially increases entrainment efficiency in gas to gas aspirators.

It is another object of the invention to provide an improved eductor-type aspirator having a gas to gas entrainment efficiency of at least three.

In accordance with the present invention the internal profile of the motive fluid nozzle in a gas to gas eductor aspirator converges arcuately, preferably with a half sinusoidal curvature, to more efficiently convert pressure energy to kinetic energy. Ranges of specific relative dimensions of the aspirator flow passages that optimize entrainment efficiency are disclosed below, as are optimal motive nozzle outlet aperture configurations.

### Terminology

It is to be understood that, unless otherwise stated or contextually evident, as used herein;
The terms “axial”, “axially”, “longitudinal”, “longitudinally”, etc., refer to dimensions extending parallel to the axis about which fluid flow is directed.
The terms “transverse”, “lateral”, etc., refer to dimensions extending perpendicularly to fluid flow direction.

### BRIEF DESCRIPTION OF THE DRAWINGS

FIG. 1 is a schematic illustration of an eductor aspirator according to the present invention.

FIG. 2 is a perspective view in longitudinal section of a first embodiment of an eductor aspirator according to the present invention.

FIG. 3 is a perspective view in longitudinal section of a second embodiment of an eductor aspirator according to the present invention.

FIG. 4 is a perspective view in longitudinal section of a third embodiment of an eductor aspirator according to the present invention.

### DESCRIPTION OF THE PREFERRED EMBODIMENTS

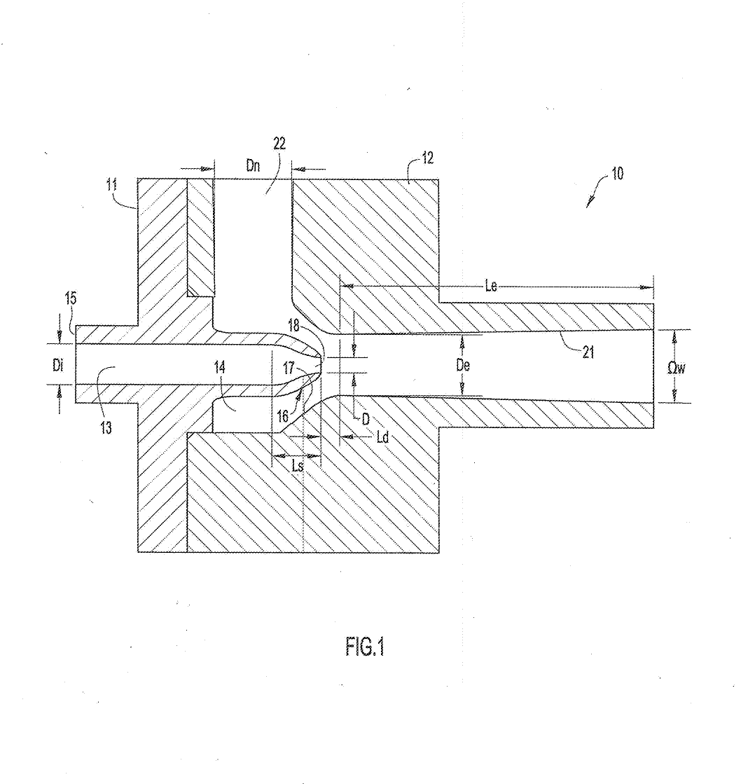

Referring specifically to FIG. 1 of the accompanying drawings, an eductor aspirator 10 is formed by nozzle body portion 11 and barrel body portion 12 that may be joined together in any manner such as adhesive, welding, screws etc., suitable to permit the aspirator perform the functions described herein. A motive fluid nozzle 13 is defined in body portion 11 and extends in a downstream direction into an interaction region 14 defined between the two body portions. The upstream portion of the interior of nozzle 13 is generally cylindrical until approaching its downstream end where it converges in a smoothly curved configuration and terminates at the nozzle tip 16 in a nozzle outlet orifice 18. The upstream or inlet end 15 of nozzle 13 is adapted to be connected to a source of pressurized motive gas which flows axially through the nozzle into the downstream end of interaction region 14 where it is issued as a gaseous jet from outlet orifice 18. Interaction region 14 annularly surrounds a downstream portion of nozzle 13 including nozzle tip 16 where the external profile of the nozzle converges.

An elongated barrel passage 21 is defined in body portion 12 and extends with a slight downstream divergence coaxially with nozzle 13 from the downstream end of interaction region 14. An entrained gas inlet passage 22 is defined in body portion 12 and is configured to permit gas to be entrained (e.g., from the ambient environment or from flow conduction means connected to passage 22) to flow into interaction region 14 when aspirated by the motive gas jet issued by nozzle 13.

The downstream portion of interaction region 14 is defined between a generally frustoconical outer wall 17 tapering in a downstream direction and the converging exterior of nozzle tip 16. That portion of the interaction region thereby has an annular transverse cross-section that gradually narrows in a downstream direction and terminates at the upstream or inlet end of barrel passage 21. Nozzle outlet orifice 18 is axially located slightly upstream of the outlet end of interaction region 14 where it is positioned to issue a jet motive gas into barrel passage 21.

In operation, the motive gas fluid jet issued from nozzle 13 aspirates entrained gas through inlet passage 22. We have found that when the internal surface or profile of nozzle tip 16 is arcuate, or curved, rather than linear as in the prior art, the entrainment efficiency of the aspirator increases significantly. In a preferred embodiment this curvature is substantially sinusoidal, a curvature configuration which we have found to have the optimal effect on the entrainment efficiency. Sinusoidal curvature in this context means that the location of any point on the on the internal wall of tip 16 can be represented by Lₛ sin θ, where Lₛ is the length of nozzle tip 16, and θ is the axial length of the nozzle tip 16 defined in angle units between 90° and 270°.

The entrainment efficiency of aspirator 10 is further enhanced when certain dimensions, illustrated in FIG. 1, are optimized. In particular:
The length of the sinusoidal profile Lₛ should be between 2D and 4D where D is the diameter of the outlet orifice 18.
Inlet diameter D_{I} of the cylindrical interior portion of nozzle 13 should range from 2D to 3D.
The distance L_{d} between the nozzle outlet orifice 18 and the upstream end of barrel passage 21 should be between 0 and D.
The minimum internal diameter Dₑ of barrel passage 21 should be between 3.5D and 4D in order to account for the addition of entrained gas in the flow.
The length Lₐ of the barrel passage 21 should be between 19D and 26D.
The divergence angle Ω_{w} of the interior wall of barrel passage 21 should be between 0° and 2°.
The minimum diameter Dₙ of the entrained gas inlet passage 22 must be between 4D and 5D in order to maximize gas entrainment for the aspirator.

In addition, we have found that the ratio ϕ of the perimeter P to the area A of outlet orifice 18 is an important factor in enhancing entrainment efficiency ν. Specifically, increasing the perimeter of an orifice of given area increases the surface area of the resulting motive gas jet which increases the amount of gas entrained for the nozzle of that given area. For example, consider a rectangular orifice of height H and width W. The expression for the perimeter of the rectangle is:

$${P}_{Rectangle } = 2 * ( \frac{{H}^{2} + {A}_{Rectangle }}{H} )$$

By taking the limit as H approaches zero:

$${lim}_{H \to 0} [ 2 * ( \frac{{H}^{2} + {A}_{Rectangle }}{H} ) ] = ∞ = {P}_{Rectangle }$$

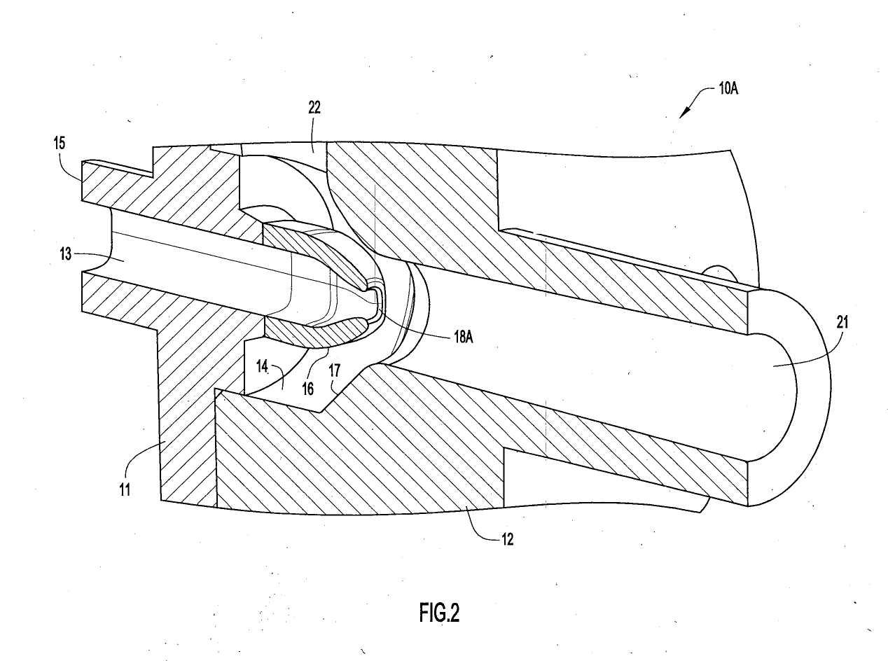

Thus, in designing an eductor aspirator of the type described above with a rectangular orifice, it is possible to increase the entrainment efficiency ν by increasing W/H, where W>>H, ultimately reaching optimum as the orifice becomes very wide and very thin. An example of an aspirator 10A having a rectangular orifice 18A is shown in FIG. 2 where all of the other components of the aspirator are designated by the same reference numerals as in FIG. 1.

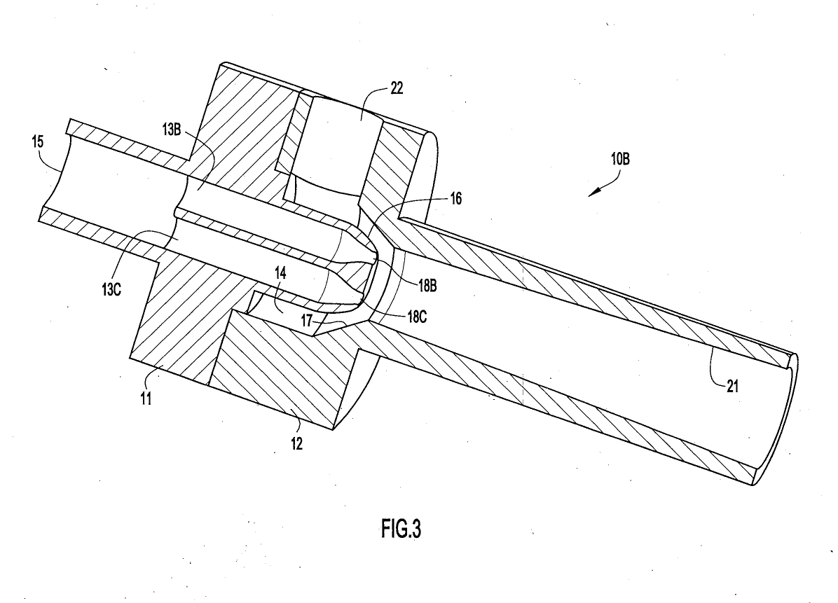

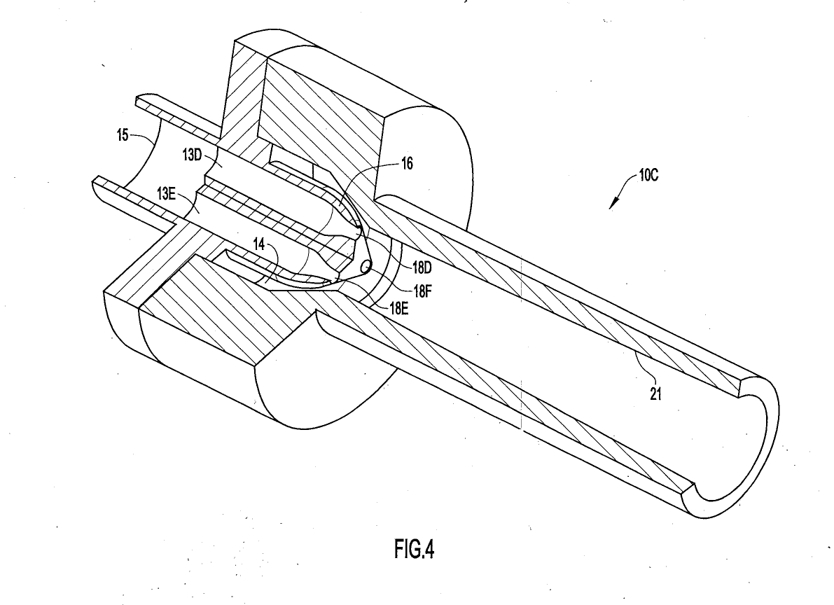

Given that a round nozzle outlet orifice is generally more easily manufactured than a thin rectangular orifice, an additional embodiment of the invention includes a multi-jet aspirator as shown in FIGS. 3 and 4. In FIG. 3 the nozzle is internally subdivided into two motive gas nozzles 13A and 13B shown in side by side relation with respective outlet orifices 18B and 18C arranged to issue parallel motive gas jets into interaction region 14 and barrel passage 21. The two jets issued in parallel increase entrainment efficiency ν by maintaining the same desired motive gas flow rate but the entrained flow rate is increased because of the increase in the aggregate perimeter provided by the adjacent and ultimately joined gaseous jets.

In the embodiment of FIG. 4, the nozzle is internally subdivided into three motive gas nozzles oriented in side by side relation with respective outlet orifices 18D, 18E and 18F arranged to issue three parallel motive gas jets into interaction region 14 and barrel passage 21. Again, the three jets issued in parallel increase entrainment efficiency ν by maintaining the same desired total motive gas flow rate but the entrained flow rate is increased because of the increase in the aggregate perimeter provided by the adjacent and ultimately joined gaseous jets.

It will be appreciated that more than three motive gas nozzles can be used without departing from the scope of the present invention.

Although several features and parameters are described herein as serving to increase entrainment efficiency ν, it should be understood that, although a combination of all of the features and parameters may provide the optimum increase in ν, the present invention contemplates that for some applications the use of only one or some combination of less than all of the features and parameters may be sufficient.

Having described preferred embodiments of new and improved gas to gas aspirator with improved entrainment efficiency, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A gas to gas eductor aspirator comprising:
an interaction region having a converging downstream end;
a nozzle for receiving a motive gas under pressure and issuing a jet of motive gas into the downstream end of said interaction region;
an entrainment gas inlet passage in flow communication with said interaction region such that the entrainment gas is entrained into said interaction region by said motive gas jet;
a barrel passage having an upstream end for receiving the motive gas jet and the entrained entrainment gas;
wherein said nozzle is configured with a distal tip having an arcuate internal profile that converges in a downstream direction and terminates in an outlet orifice from which said jet is issued.

2. The aspirator of claim 1 wherein said arcuate internal profile of said nozzle tip has a generally sinusoidal convergence curvature.

3. The aspirator of claim 2 wherein said sinusoidal convergence curvature is represented by Lₛ sin θ, where Lₛ is the length of nozzle tip and θ is the axial length of the nozzle tip 16 defined in angle units between 90° and 270°.

4. The aspirator of claim 2 wherein the length Lₛ of the nozzle tip is between 2D and 4D where D is the diameter of said outlet orifice.

5. The aspirator of claim 4 wherein the distance L_{d} between said nozzle outlet orifice and the upstream end of barrel passage is between 0 and D.

6. The aspirator of claim 5 wherein the minimum internal diameter Dₑ of said barrel passage is between 3.5D and 4D.

7. The aspirator of claim 6 wherein the barrel passage has a divergence angle Ω_{w} between 0° and 2°.

8. The aspirator of claim 1 wherein the length Lₛ of the nozzle tip is between 2D and 4D where D is the diameter of said outlet orifice.

9. The aspirator of claim 1 wherein the distance L_{d} between said nozzle outlet orifice and the upstream end of barrel passage is between 0 and D where D is the diameter of said outlet orifice.

10. The aspirator of claim 1 wherein the minimum internal diameter Dₑ of said barrel passage is between 3.5D and 4D where D is the diameter of said outlet orifice.

11. The aspirator of claim 1 wherein the barrel passage has a divergence angle Ω_{w} between 0° and 2°.

12. The aspirator of claim 1 wherein said outlet orifice is rectangular with a width W and a height H, and wherein W>>H.

13. The aspirator of claim 1 wherein said nozzle is internally subdivided into plural motive gas nozzles in side by side relation with respective outlet orifices arranged to issue plural respective parallel motive gas jets into said interaction region and said barrel passage for entraining said entrainment gas.

14. The aspirator of claim 13 wherein said arcuate internal profile of said nozzle tip has a generally sinusoidal convergence curvature.

15. The aspirator of claim 1 wherein said nozzle is internally subdivided into three motive gas nozzles in side by side relation with respective outlet orifices arranged to issue three respective parallel motive gas jets into said interaction region and said barrel passage for entraining said entrainment gas.

16. The aspirator of claim 15 wherein said arcuate internal profile of said nozzle tip has a generally sinusoidal convergence curvature.

17. The aspirator of claim 1 wherein said arcuate internal profile of said nozzle tip has a generally sinusoidal convergence curvature, and wherein said barrel passage has a length between 19D and 26D, where D is the diameter of said outlet orifice.

18. The aspirator of claim 17 wherein the diameter D_{I} of the interior of said nozzle upstream of the nozzle tip is in the range from 2D to 3D.

19. The aspirator of claim 18 wherein the length Lₛ of the nozzle tip is between 2D and 4D and the distance L_{d} between said nozzle outlet orifice and the upstream end of barrel passage is between 0 and D.

20. The aspirator of claim 1 wherein said arcuate internal profile of said nozzle tip has a generally sinusoidal convergence curvature and said aspirator has an entrainment efficiency ν greater than 3.
